(19) United States
(12) Patent Application Publication
(10) Pub. No.: US 2014/0149099 A1
(43) Pub. Date: May 29, 2014

(54) METHOD OF CONFIGURING LARGE SIGNAL MODEL OF ACTIVE DEVICE

(71) Applicant: Electronics and Telecommunications Research Institute, Daejeon (KR)

(72) Inventor: Woojin CHANG, Daejeon (KR)

(21) Appl. No.: 13/911,189

(22) Filed: Jun. 6, 2013

(30) Foreign Application Priority Data
Nov. 29, 2012 (KR) 10-2012-0137319

(51) Int. Cl. G06F 17/50

(52) U.S. Cl. CPC G06F 17/5045
USPC 703/14

(57) ABSTRACT

Provided is a method of configuring a large signal model of an active device. The method may include configuring a large signal model of a first active device, preparing a first measured value on a first characteristic of a second active device, the second active device being larger than the first active device, processing the large signal model of the first active device using a circuit simulator to configure a large signal model of the second active device, simulating the large signal model of the second active device to obtain a calculated value on the first characteristic, comparing the measured and calculated values on the first characteristic to each other, and establishing the large signal model of the second active device, if a difference between the measured and calculated values on the first characteristic may be smaller than a predetermined error margin. Further, if the difference between the measured and calculated values on the first characteristic may be greater than the predetermined error margin, the large signal model of the second active device may be configured by modifying parameters of passive devices.

### CROSS-REFERENCE TO RELATED APPLICATIONS

This U.S. non-provisional patent application claims priority under 35 U.S.C. §119 to Korean Patent Application No. 10-2012-0137319, filed on Nov. 29, 2012, in the Korean Intellectual Property Office, the entire contents of which are hereby incorporated by reference.

### BACKGROUND OF THE INVENTION

Example embodiments of the inventive concept relate to a method of configuring a large signal model of an active device.

A modeling of an active device is essentially required to design an integrated circuit including an active device. If the model for the active device is exact, it may be possible to facilitate design and fabrication of integrated circuits and predict quickly and exactly real characteristics of the integrated circuits. Further, accuracy of the active device model may affect time taken to design and fabricate an integrated circuit.

The active device modeling may be achieved using measurement data. However, as the result of limitations related to a measurement range of a measuring instrument or a measurement environment, some (e.g., a large active device) of the active devices may be measured over a partial range. Accordingly, it is hard to prepare a model for the large active device directly. Alternatively, a scaling-allowed model has been developed, but it suffers from large error.

In addition, characteristics (e.g., DC and RF characteristics) should be measured to prepare a model for an active device. For the DC characteristic, even the large active device may be measured over the whole measurement range, due to advances in measuring instrument technology. However, there is a limitation in measuring the RF characteristic of an active device whose size is larger than a specific size, due to limitation related to measuring instruments. This means that there is a difficulty in modeling a large active device.

### SUMMARY

According to example embodiments of the inventive concept, a large signal model of a small active device, whose characteristics can be measured over the whole measurement range, may be configured, and then, the large signal model of the small active device may be processed or simulated to configure a large signal model of a large active device, whose characteristics can be measured over a partial measurement range.

According to example embodiments of the inventive concepts, a method of configuring a large signal model of an active device may include configuring a large signal model of a first active device, preparing a first measured value on a first characteristic of a second active device, the second active device being larger than the first active device, processing the large signal model of the first active device using a circuit simulator to configure a large signal model of the second active device, simulating the large signal model of the second active device to obtain a calculated value on the first characteristic, comparing the measured and calculated values on the first characteristic to each other, and establishing the large signal model of the second active device, if a difference between the measured and calculated values on the first characteristic may be smaller than a predetermined error margin. Further, if the difference between the measured and calculated values on the first characteristic may be greater than the predetermined error margin, the large signal model of the second active device may be configured by modifying parameters of passive devices.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a flow chart briefly illustrating a method of configuring a large signal model of an active device according to example embodiments of the inventive concept.

FIG. 2 is a flow chart illustrating a method of configuring a large signal model of the small active device of FIG. 1.

FIG. 3 is a flow chart illustrating a method of configuring a large signal model of the large active device of FIG. 1.

FIG. 4 is a circuit diagram illustrating an example of parallel connection of small active devices, according to example embodiments of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, a small active device and a large active device will be mentioned as unit elements in a description for example embodiments of the inventive concept. The small active device may refer to an active device, whose characteristics can be measured over the whole measurement range. The large active device may refer to an active device, whose characteristics can be measured over only a partial measurement range. However, example embodiments of the inventive concepts may not be limited thereto.

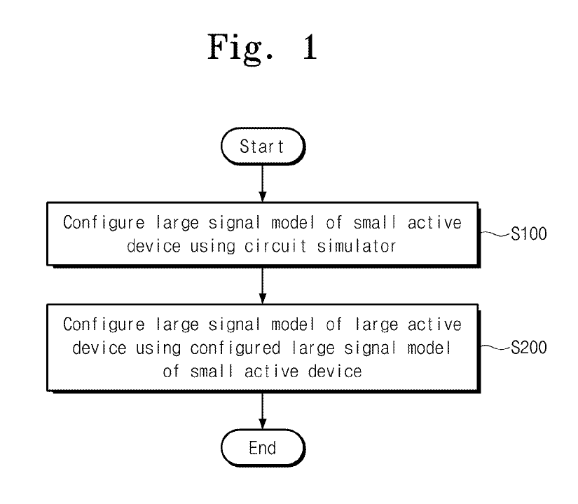

FIG. 1 is a flow chart briefly illustrating a method of configuring a large signal model of an active device according to example embodiments of the inventive concept.

In step of S100, characteristics (e.g., DC and RF characteristics) of a small active device may be measured over the whole measurement range using a measuring instrument. A large signal model of the small active device may be configured by comparing the measured data and simulation data obtained from a circuit simulator.

In step of S200, characteristics (e.g., DC and RF characteristics) of a large active device may be measured over a partial measurement range using the measuring instrument. To configure a large signal model of the large active device, the large signal model of the small active device prepared in step of S100 may be processed or simulated using data measured from the large active device.

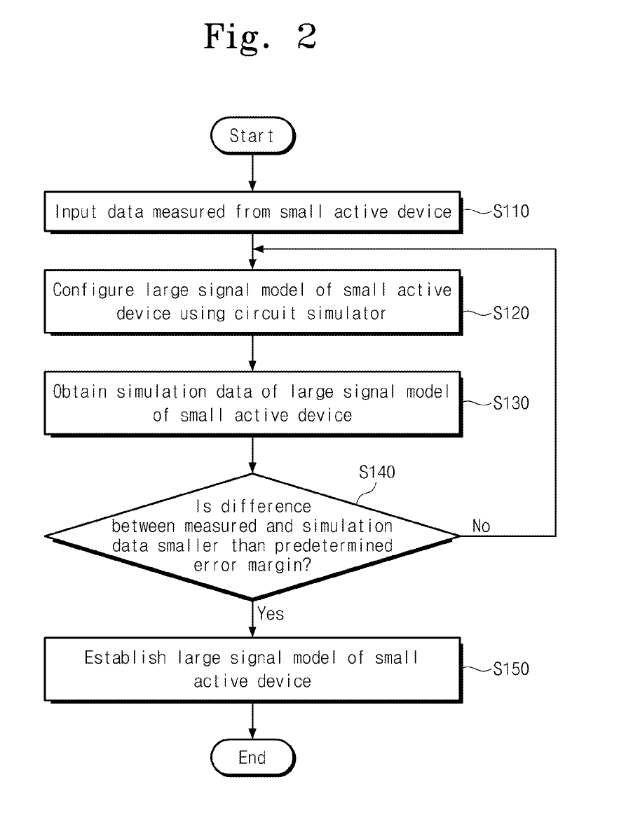

FIG. 2 is a flow chart illustrating a method of configuring a large signal model of the small active device of FIG. 1. For example, the step of S100 will be described in more detail with reference to FIG. 2.

In step of S110, data measured from the small active device may be input. For example, characteristics (e.g., DC and RF characteristics) of the small active device may be measured over the whole measurement range. The measured data may be used as comparison data, when the large signal model of the small active device will be established.

In step of S120, a circuit simulator may be used to configure the large signal model of the small active device. The large signal model of the small active device may be formed with passive devices, such as resistor, capacitor, and inductor. The large signal model in this step may not be established yet. The circuit simulator may be an advanced design system (ADS), but example embodiments of the inventive concepts may not be limited thereto.

In step of S130, simulation data of the large signal model of the small active device configured in the step of S120 may be obtained. The obtained simulation data may be compared with the measured data input in the step of S110 and be used to establish the large signal model of the small active device.

In step of S140, an evaluation step may be performed to evaluate whether a difference between the measured data of the small active device input in the step of S110 and the simulation data of the large signal model of the small active device in the step of S120 is smaller than a predetermined error margin or not. The error margin may be modified depending on a desired accuracy level for the large signal model. If the difference between the measurement and simulation data is smaller than the predetermined error margin, a subsequent step of S150 may be performed. Otherwise, the step of S120 may be performed again, and the large signal model of the small active device may be re-configured by modifying parameters of the passive devices. The steps of S120 through S140 may be repeatedly performed.

In step of S150, the large signal model of the small active device may be established as a final model. The established large signal model of the small active device may be used to configure the large signal model of the large active device. In example embodiments, the higher the accuracy of the large signal model of the small active device, the higher the accuracy of the large signal model of the large active device.

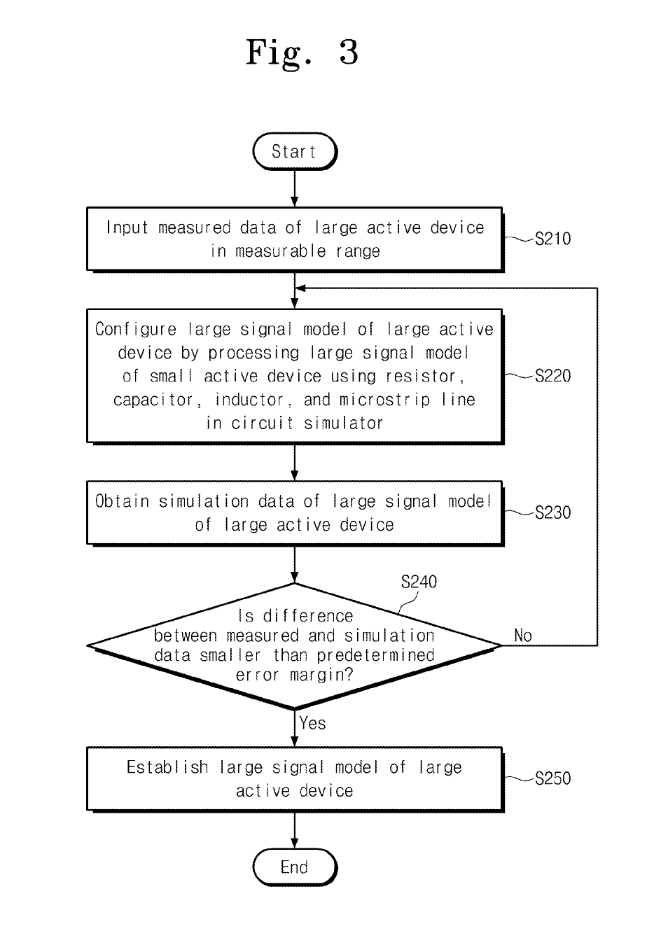

FIG. 3 is a flow chart illustrating a method of configuring a large signal model of the large active device of FIG. 1. For example, the step of S200 will be described in more detail with reference to FIG. 3.

In step of S210, measured data of the large active device in a measurable range may be input. In a low range of voltage or current, electric characteristics (e.g., DC and RF) of the large active device may be measured. The measured data to be input may be used as comparison data, when the large signal model of the large active device will be established.

In step of S220, the large signal model of the small active device may be processed or simulated by the circuit simulator to configure the large signal model of the large active device including a plurality of small active devices connected in parallel to each other. The large signal model in this step may not be established yet. The circuit simulator may be an advanced design system (ADS), but example embodiments of the inventive concepts may not be limited thereto. In example embodiments, the step of S220 may be executed using the same circuit simulator as that used in the step of S110. When the large signal model of the large active device is configured or the large signal model of the small active device is processed or simulated, a resistor, a capacitor, an inductor, a microstrip line, and so forth are connected in series or parallel to each other.

In step of S230, simulation data of the large signal model of the large active device configured in the step of S220 may be obtained. The obtained simulation data may be compared with the measured data input in the step of S210 and be used to establish the large signal model of the large active device.

In step of S240, an evaluation step may be performed to evaluate whether a difference between the measured data of the large active device input in the step of S210 and the simulation data of the large signal model of the large active device in the step of S220 is smaller than a predetermined error margin or not. The error margin may be modified depending on a desired accuracy level for the large signal model. If the difference between the measurement and simulation data is smaller than the predetermined error margin, a subsequent step of S250 may be performed. Otherwise, the step of S220 may be performed again, and the large signal model of the large active device may be re-configured by modifying parameters of the passive devices. The steps of S220 through S240 may be repeatedly performed.

In step of S250, the large signal model of the large active device may be established as a final model. According to example embodiments of the inventive concept, the large signal model of the large active device may be configured by processing, merging or simulating the large signal model of the small active device.

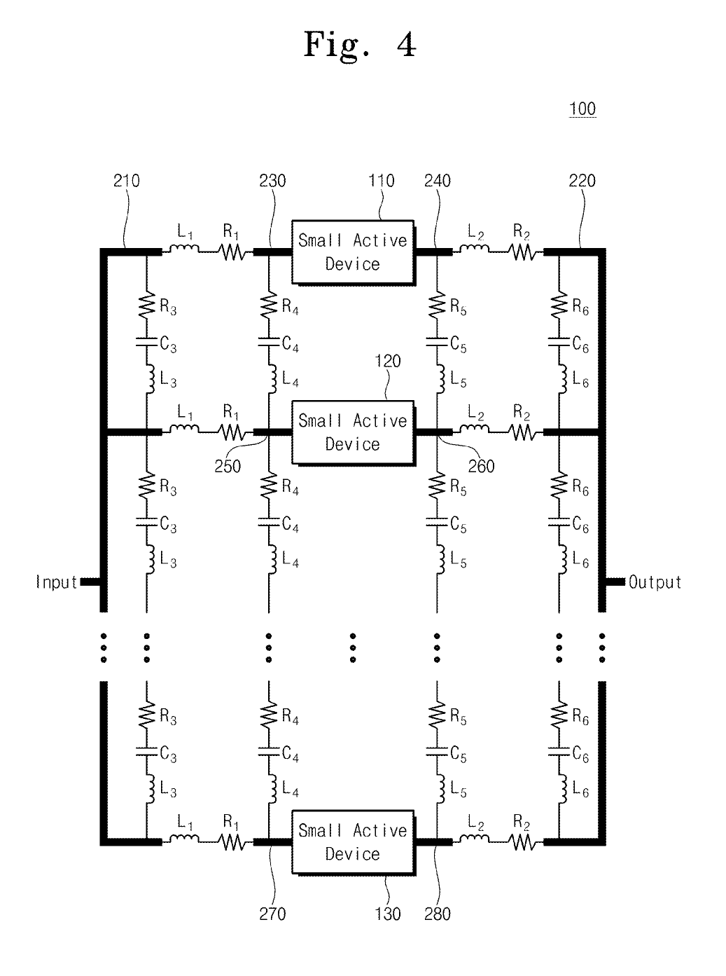

FIG. 4 is a circuit diagram illustrating an example of parallel connection of small active devices, according to example embodiments of the inventive concept. The small active devices 110, 120, and 130 may be connected in parallel to each other. A connection structure between the small active devices 110, 120, and 130 will be described below.

An inductor L1 may be provided in series between a small active device 110 and an input node to control RF signal loss. A resistor R1 may be provided in series between the small active device 110 and the input node to control DC and RF signal loss. A microstrip line 210 may connect the input node to the inductor L1, and a microstrip line 230 connect the resistor R1 and the small active device 110. The inductor L1 may be connected to the resistor R1.

An inductor L2 may be provided in series between the small active device 110 and an output node to control RF signal loss. A resistor R2 may be provided in series between the small active device 110 and the output node to control DC and RF signal loss. A microstrip line 220 may connect the output node to the resistor R2,and a microstrip line 240 may connect the inductor L2 to the small active device 110. The inductor L2 may be connected to the resistor R2.

A resistor R3, a capacitor C3, and an inductor L3 may be connected in parallel to the microstrip line 210. The resistor R3, the capacitor C3, and the inductor L3 may control RF signal interference of the input node. The resistor R3 may be connected to the microstrip line 210. The capacitor C3 may be connected to the resistor R3. The inductor L3 may be connected to the capacitor C3.

A resistor R6, a capacitor C6, and an inductor L6 may be connected in parallel to the microstrip line 220. The resistor R6, the capacitor C6, and the inductor L6 may control RF signal interference of the output node. The resistor R6 may be connected to the microstrip line 220. The capacitor C6 may be connected to the resistor R6. The inductor L6 may be connected to the capacitor C6.

A resistor R4, a capacitor C4, and an inductor L4 may be connected in parallel between two small active devices 110 and 120 to control input bias and input signal loss between the active devices 110 and 120. The resistor R4 may be connected to the microstrip line 230. The capacitor C4 may be connected to the resistor R4. The inductor L4 may be connected to the capacitor C4. The microstrip line 250 may be connected to the inductor L4.

A resistor R5, a capacitor C5, and an inductor L5 may be connected in parallel between two small active devices 110 and 120 to control output bias and output signal loss between the active devices 110 and 120. The resistor R5 may be connected to the microstrip line 240. The capacitor C5 may be connected to the resistor R5. The inductor L5 may be connected to the capacitor C5. The microstrip line 260 may be connected to the inductor L5.

The small active devices 120 and 130 may be connected in parallel to each other in the afore-mentioned manner. The number of the small active devices 110, 120, and 130 to be connected in parallel to each other may be adjusted depending on a size of the large active device 100. The microstrip lines 210 to 280 may be connected in parallel. In example embodiments, positions and/or structures of the passive devices may be modified. The step of S220 shown in FIG. 3 may be performed to configure the large signal model of the large active device for a circuit of FIG. 4. Parameters related to the passive devices may be modified during configuring the large signal model of the large active device.

According to example embodiments of the inventive concept, a large signal model may be configured for a large active device, whose characteristics are hard to be measured over the whole measurement range. The large signal model of the large active device may be used for designing an integrated circuit including such a large active device, and this makes it possible to facilitate the design process and reduce the time taken to design the integrated circuit. Further, this makes it possible to predict quickly real characteristics of the integrated circuits.

While example embodiments of the inventive concepts have been particularly shown and described, it will be understood by one of ordinary skill in the art that variations in form and detail may be made therein without departing from the spirit and scope of the attached claims.

What is claimed is:

1. A method of configuring a large signal model of an active device, comprising:
configuring a large signal model of a first active device;
preparing a first measured value on a first characteristic of a second active device, the second active device being larger than the first active device;
processing the large signal model of the first active device using a circuit simulator to configure a large signal model of the second active device;
simulating the large signal model of the second active device to obtain a calculated value on the first characteristic;
comparing the measured and calculated values on the first characteristic to each other; and
establishing the large signal model of the second active device, if a difference between the measured and calculated values on the first characteristic is smaller than a predetermined error margin.

2. The method of claim 1, wherein if the difference between the measured and calculated values on the first characteristic is greater than the predetermined error margin, the large signal model of the second active device is configured by modifying parameters of passive devices.

3. The method of claim 1, wherein the configuring of the large signal model of the first active device comprises:
preparing a measured value on a second characteristic of the first active device;
configuring the large signal model of the first active device using the circuit simulator;
simulating the large signal model of the first active device to obtain a calculated value on the second characteristic;
comparing the measured and calculated values on the second characteristic to each other; and
establishing the large signal model of the first active device, if a difference between the measured and calculated values on the second characteristic is smaller than a predetermined error margin.

4. The method of claim 3, wherein if the difference between the measured and calculated values on the second characteristic is greater than the predetermined error margin, the large signal model of the first active device is configured by modifying parameters of the passive devices.

5. The method of claim 1, wherein the large signal model of the second active device is configured by connecting the first active devices in parallel to each other using a resistor, a capacitor, an inductor, and a microstrip line.
